(19) United States
(12) Patent Application Publication
(10) Pub. No.: US 2016/0110315 A1
(43) Pub. Date: Apr. 21, 2016

(54) METHODS AND SYSTEMS FOR DIGITIZING A DOCUMENT

(71) Applicants: Xerox Corporation, Norwalk, CT (US); Palo Alto Research Center Incorporated, Palo Alto, CA (US)

(72) Inventors: Shailesh Vaya, Bangalore (IN); Sakyajit Bhattacharya, Bangalore (IN); Sugato Chakrabarty, Bangalore (IN); Gregory M. Youngblood, San Jose, CA (US); Kunal Chawla, Punjab (IN)

(21) Appl. No.: 14/517,989

(22) Filed: Oct. 20, 2014

(51) Int. Cl. G06F 17/21; G06F 17/30; G06F 17/24

(52) U.S. Cl. CPC G06F 17/212; G06F 17/24; G06F 17/30011

(57) ABSTRACT

The disclosed embodiments illustrate methods and systems for digitizing a document. The method includes receiving at least one first transcription of content of at least one portion of the document from at least one crowdworker, in response to the at least one portion being crowdsourced as a digitization task to the at least one crowdworker. Thereafter, one or more second transcriptions are determined based on the at least one first transcription. The one or more second transcriptions correspond to intended transcriptions for the at least one portion. Further, the one or more second transcriptions are ranked based at least on a measure of similarity between the at least one first transcription and each of the one or more second transcriptions. At least one second transcription is selected from the one or more second transcriptions as an acceptable transcription for the at least one portion based on the ranking.

### TECHNICAL FIELD

The presently disclosed embodiments are related, in general, to crowdsourcing. More particularly, the presently disclosed embodiments are related to methods and systems for digitizing a document through crowdsourcing.

### BACKGROUND

With the advancements in the communication technology and the penetration of the internet services to the masses, crowdsourcing has emerged as a source of remuneration for many. Further, from the perspective of enterprises, the emergence of crowdsourcing has brought a new opportunity to cost-effectively outsource tasks related to various business operations of the enterprise. Examples of tasks crowdsourced by the enterprises include, but are not limited to, form digitization tasks, image tagging/labeling tasks, content editing/proofing tasks, and so forth. However, responses to such tasks are prone to manual errors such as typos, errors of omission/commission, and the like. Hence, there exists a need for a solution to rectify such manual errors that may be committed while performing such tasks.

### SUMMARY

According to embodiments illustrated herein, there is provided a method for digitizing a document. The method includes receiving, by one or more processors, at least one first transcription of content of at least one portion of the document from at least one crowdworker. The first transcription is received in response to the at least one portion being crowdsourced as a digitization task to the at least one crowdworker. Thereafter, one or more second transcriptions are determined, by the one or more processors, based on the at least one first transcription. The one or more second transcriptions correspond to intended transcriptions for the at least one portion. Further, the one or more second transcriptions are ranked, by the one or more processors, based at least on a measure of similarity between the at least one first transcription and each of the one or more second transcriptions. At least one second transcription is selected from the one or more second transcriptions as an acceptable transcription for the at least one portion, based on the ranking.

According to embodiments illustrated herein, there is provided a system for digitizing a document. The system includes one or more processors that are configured to receive at least one first transcription of content of at least one portion of the document from at least one crowdworker. The first transcription is received in response to the at least one portion being crowdsourced as a digitization task to the at least one crowdworker. Thereafter, one or more second transcriptions are determined based on the at least one first transcription. The one or more second transcriptions correspond to intended transcriptions for the at least one portion. Further, the one or more second transcriptions are ranked based at least on a measure of similarity between the at least one first transcription and each of the one or more second transcriptions. At least one second transcription is selected from the one or more second transcriptions as an acceptable transcription for the at least one portion, based on the ranking.

According to embodiments illustrated herein, there is provided a computer program product for use with a computing device. The computer program product comprises a non-transitory computer readable medium, the non-transitory computer readable medium stores a computer program code for digitizing a document. The computer readable program code is executable by one or more processors in the computing device to receive at least one first transcription of content of at least one portion of the document from at least one crowdworker. The first transcription is received in response to the at least one portion being crowdsourced as a digitization task to the at least one crowdworker. Thereafter, one or more second transcriptions are determined based on the at least one first transcription. The one or more second transcriptions correspond to intended transcriptions for the at least one portion. Further, the one or more second transcriptions are ranked based at least on a measure of similarity between the at least one first transcription and each of the one or more second transcriptions. At least one second transcription is selected from the one or more second transcriptions as an acceptable transcription for the at least one portion, based on the ranking.

According to embodiments illustrated herein, there is provided a method for processing a task. The method includes receiving, by one or more processors, at least one first response for the task from at least one crowdworker. The at least one first response is received, by the one or more processors, in response to the task being crowdsourced to one or more crowdworkers. Thereafter, one or more second responses are received, by the one or more processors, based on the at least one first response. The one or more second responses correspond to intended responses for the task. Further, the one or more second responses are ranked, by the one or more processors, based at least on a measure of similarity between the at least one first response and each of the one or more second responses. At least one second response is selected from the one or more second responses as an acceptable response for the task, based on the ranking.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a block diagram of a system environment in which various embodiments can be implemented;

FIG. 2 is a block diagram that illustrates a system for crowdsourcing a task, in accordance with at least one embodiment;

FIG. 3 is a flowchart that illustrates a method for crowdsourcing a task, in accordance with at least one embodiment;

FIG. 4 is a flowchart that illustrates a method for digitizing a document, in accordance with at least one embodiment; and

FIG. 5 is a flow diagram illustrating an example of digitization of a document, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

### DEFINITIONS

The following terms shall have, for the purposes of this application, the meanings set forth below.

A “task” refers to a piece of work, an activity, an action, a job, an instruction, or an assignment to be performed. Tasks may necessitate the involvement of one or more workers. Examples of tasks include, but are not limited to, digitizing a document, generating a report, evaluating a document, conducting a survey, writing a code, extracting data, translating text, and the like.

“Crowdsourcing” refers to distributing tasks by soliciting the participation of loosely defined groups of individual crowdworkers. A group of crowdworkers may include, for example, individuals responding to a solicitation posted on a certain website such as, but not limited to, Amazon Mechanical Turk and Crowd Flower.

A “crowdsourcing platform” refers to a business application, wherein a broad, loosely defined external group of people, communities, or organizations provide solutions as outputs for any specific business processes received by the application as inputs. In an embodiment, the business application may be hosted online on a web portal (e.g., crowdsourcing platform servers). Examples of the crowdsourcing platforms include, but are not limited to, Amazon Mechanical Turk or Crowd Flower.

A “crowdworker” refers to a workforce/worker(s) that may perform one or more tasks, which generate data that contributes to a defined result. According to the present disclosure, the crowdworker(s) includes, but is not limited to, a satellite center employee, a rural business process outsourcing (BPO) firm employee, a home-based employee, or an internet-based employee. Hereinafter, the terms “crowdworker”, “worker”, “remote worker”, “crowdsourced workforce”, and “crowd” may be interchangeably used.

A “response” refers to a solution or work product corresponding to a task, which may be received from one or more crowdworkers to whom the task is crowdsourced.

An “intended response” refers to a probable response that a crowdworker may have intended to provide while performing the task.

An “electronic document” or “digital image” or “scanned document” refers to information recorded in a manner that requires a computing device or any other electronic device to display, interpret, and process it. Electronic documents are intended to be used either in an electronic form or as printed output. In an embodiment, the electronic document includes one or more of text (handwritten or typed), image, symbols, and so forth. In an embodiment, the electronic document is obtained by scanning a document using a suitable scanner, a multi-function device, a camera or a camera-enabled device including but not limited to a mobile phone, a tablet computer, desktop computer or a laptop. In an embodiment, the scanned document may correspond to a digital image of a handwritten document. The digital image may contain one or more pictorials, symbols, text, line art, blank or non-printed regions, etc. The digital image may be stored in various file formats, such as, JPG or JPEG, GIF, TIFF, PNG, BMP, RAW, PSD, PSP, PDF, and the like. Hereinafter, the terms “electronic document,” “scanned document,” “image,” and “digital image” are interchangeably used without departing from the scope of the ongoing description.

“Transcription” refers to a data entry corresponding to content in an electronic document. In an embodiment, the data entry includes inputting one or more numerals or characters for a given field of the electronic document. In an embodiment, in response to crowdsourcing a portion of an electronic document for digitization, one or more responses may be received from one or more crowdworkers. Each such response may include a transcription of the portion of the electronic document.

“Digitization” refers to a process of conversion of non-machine readable content in an electronic document into a machine readable/recognizable content. In an embodiment, the digitization of the electronic document may be performed using one or more image processing techniques such as Optical Character Recognition (OCR) or Intelligent Character Recognition (ICR). In an embodiment, at least one portion of the electronic document may include a handwritten text, which may not be digitized through the one or more image processing techniques and may be digitized through crowdsourcing. In response to crowdsourcing the at least one portion of the document as a digitization task to one or more crowdworkers, at least one transcription may be received from the one or more crowdworkers. The at least one transcription may correspond to a digitized version of the handwritten text.

“Remuneration” refers to rewards received by the one or more crowdworkers for attempting/submitting the one or more tasks. In an embodiment, the remuneration is a monetary compensation received by the one or more crowdworkers. However, a person having ordinary skills in the art would understand that the scope of the disclosure is not limited to remunerating the one or more crowdworkers with monetary compensation. In an embodiment, various other means of remunerating the one or more crowdworkers may be employed such as, remunerating the owners with lottery tickets, giving gift items, shopping vouchers, and discount coupons. In another embodiment, the remuneration may further correspond to strengthening of the relationship between the one or more crowdworkers and the crowdsourcing platform. For example, the crowdsourcing platform may provide the crowdworker with an access to more tasks so that the crowdworker may gain more. In addition, the crowdsourcing platform may improve the reputation score of the crowdworker so that more tasks are assigned to the crowdworker. A person skilled in the art would understand that combination of any of the above-mentioned means of remuneration could be used for remunerating the one or more crowdworkers. Further, the term “bonus remuneration” refers to an extra remuneration received by the one or more crowdworkers, in addition to the standard remuneration received for attempting/submitting the one or more tasks.

A “performance score” refers to a score assigned to a crowdworker based on his/her performance of various tasks through the crowdsourcing platform. In an embodiment, the performance score may be determined as a ratio of correctly attempted tasks to the total number of tasks attempted by the crowdworker. In addition, the performance score may also be determined based on other factors such as, but not limited to, the crowdworkers accuracy in performing the tasks, his/her turn-around time on each task, availability for performing the tasks posted on the crowdsourcing platform, and so on.

A “reputation score” refers to a score assigned to a crowdworker based on his/her interactions with the crowdsourcing platform. In an embodiment, the reputation score may correspond to level associated with the crowdworker based on his/her historical performance trend. For example, a crowdworker who is consistent in his/her performance scores (e.g., a crowdworker with performance scores greater than 70% on more than 90% occasions) may be assigned a high reputation score. Further, in an embodiment, such a crowdworker may be provided with a higher remuneration than other crowdworkers with a lower reputation score.

A “measure of similarity” refers to a degree of similarity of a first text string to a second text string. In an embodiment, the measure of similarity may be determined as a minimum number of edits required to convert the first text to the second text. In an embodiment, an edit may correspond to an addition, a deletion, or a substitution of a character in a source string, i.e., the first text string.

“One or more domain documents” refer to a set of documents that are related to a domain. In an embodiment, the domain associated with the document may be determined by analyzing a content of the document through one or more image processing techniques or one or more machine learning techniques.

A “domain” refers to a field of knowledge/work/expertise/enterprise pertaining to a document of interest. In an embodiment, the domain associated with a document may be determined from the document's content and structure. For example, a document related to the domain of taxation may contain various fields related to income, savings, rebates, tax slabs, and so on.

A “language model” refers to a model that associates words/phrases/sentences with their degree of usage in the language. Hence, a more frequently used word may be assigned a higher weight/probability/score in the language model. In an embodiment, a probability of occurrence of a word/phrase/sentence within one or more domain documents may be determined based on a language model developed from the one or more domain documents.

A “statistical model” refers to a mathematical relationship between one or more input parameters and one or more output statistics. In an embodiment, the statistical model may correspond to a language model. In such a scenario, the statistical model may relate words/phrases/sentences within one or more domain documents to their probability of occurrences.

A “data structure” refers to a grouping of data that is represented in a particular format for storage or further processing. In an embodiment, the data structure may store a statistical model. Examples of the data structure include, but are not limited to, a Bloom filter, a Tries, or a BK tree.

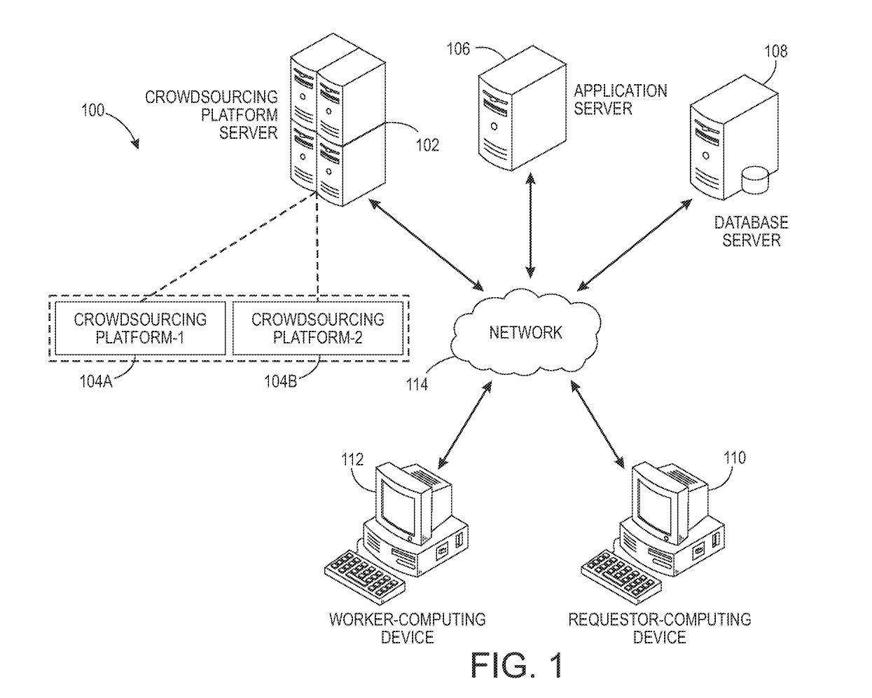

FIG. 1 is a block diagram of a system environment 100, in which various embodiments can be implemented. The system environment 100 includes a crowdsourcing platform server 102, an application server 106, a requestor-computing device 108, a database server 110, a worker-computing device 112, and a network 114.

In an embodiment, the crowdsourcing platform server 102 is configured to host one or more crowdsourcing platforms (e.g., a crowdsourcing platform-1 104a and a crowdsourcing platform-2 104b). One or more crowdworkers are registered with the one or more crowdsourcing platforms. Further, the crowdsourcing platform (such as the crowdsourcing platform-1 104a or the crowdsourcing platform-2 104b) may crowdsource one or more tasks by offering the one or more tasks to the one or more crowdworkers. In an embodiment, the crowdsourcing platform (for e.g., 104a) presents a user interface to the one or more crowdworkers through a web-based interface or a client application. The one or more crowdworkers may access the one or more tasks through the web-based interface or the client application. Further, the one or more crowdworkers may submit a response to the crowdsourcing platform (i.e., 104a) through the user interface.

A person skilled in the art would understand that though FIG. 1 illustrates the crowdsourcing platform server 102 as hosting only two crowdsourcing platforms (i.e., the crowdsourcing platform-1 104a and the crowdsourcing platform-2 104b), the crowdsourcing platform server 102 may host more than two crowdsourcing platforms without departing from the spirit of the disclosure. Alternatively, the crowdsourcing platform server 102 may host a single crowdsourcing platform.

In an embodiment, the crowdsourcing platform server 102 may be realized through an application server such as, but not limited to, a Java application server, a .NET framework, and a Base4 application server.

In an embodiment, the application server 106 may include programs/modules/computer executable instructions that may be representative of a statistical model. In an embodiment, the application server 106 may receive a task from a requestor. For example, the task may correspond to digitization of one or more documents. Based on analysis of the one or more documents corresponding to the task, in an embodiment, the application server 106 may determine the domain of the task. Further, the requestor may provide information associated with the task, which may be utilized to determine the domain of the task. For example, the requestor may provide an input that the task corresponds to digitization of a legal document. The requestor may also provide an input corresponding to the type of the legal form, for example, an affidavit form. Based on the domain of the task so determined, in an embodiment, the application server 106 may select a suitable statistical model. For example, the application server 106 may select the statistical model corresponding to the legal domain if the domain of the task is the legal domain.

Prior to receiving the task, the application server 106 may train one or more domain specific statistical models by utilizing one or more domain documents corresponding to various domains. For example, the application server 106 may create a first statistical model pertaining to the legal domain by analyzing one or more documents related to the legal domain. Further, the application server 106 may create a second statistical model for the financial reporting domain by analyzing one or more documents related to the financial domain. A person skilled in the art would appreciate that such statistical models may be updated based on fresh set of documents related to the respective domain. In an alternate embodiment, the application server 106 may create a statistical model in real time. For instance, if the domain of the task does not correspond to the domain of any of the existing statistical models, the application server 106 may train a new statistical model in real time. In an embodiment, the one or more documents related to such domain may be obtained from various sources such as internet repositories, search engines, and so on. In an embodiment, the statistical model may be stored in a data structure such as, but not limited to, a Bloom filter, a Tries, or a BK tree. In an embodiment, the statistical model is stored within the data structure on the database server 108.

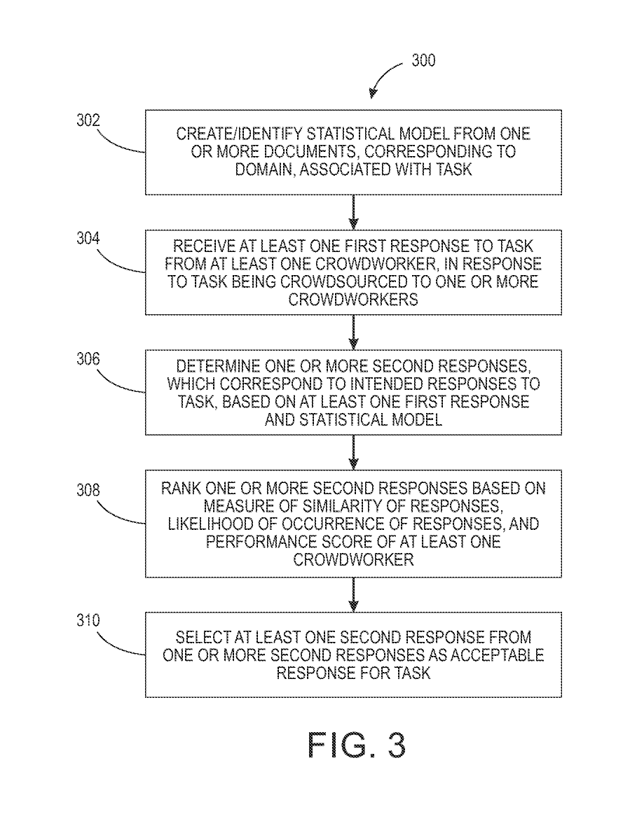

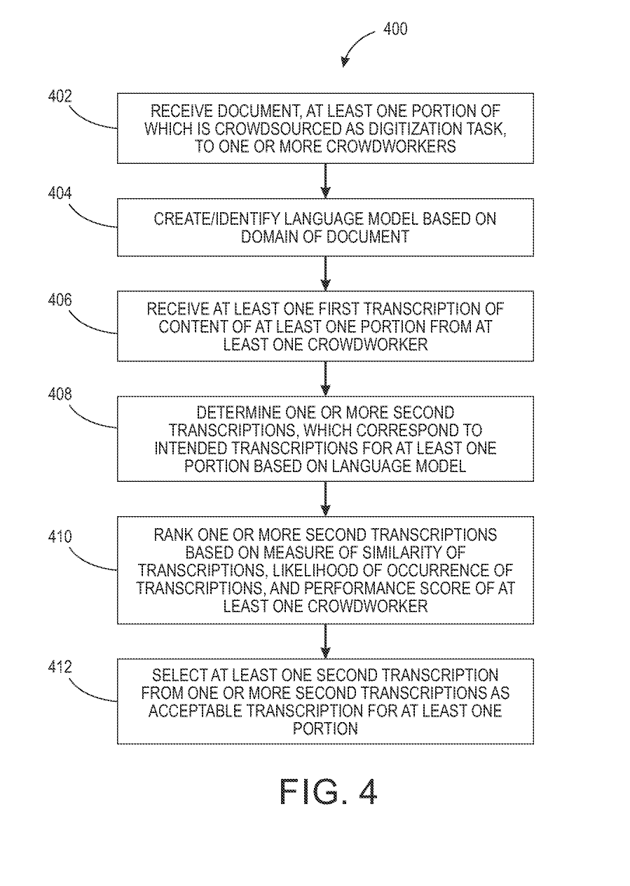

Further, in an embodiment, the application server 106 may upload the task on the crowdsourcing platform, e.g., 104a, which may in-turn crowdsource the task to the one or more crowdworkers. Further, in response to crowdsourcing the task, the application server 106 may receive at least one first response to the task (through the crowdsourcing platform, e.g., 104a), from at least one of the one or more crowdworkers. Thereafter, based on the at least one first response and the statistical model, in an embodiment, the application server 106 may determine one or more second responses, which may correspond to intended responses to the task. In an embodiment, the application server 106 may determine a measure of similarity between the at least one first response and each of the one or more second responses. In an embodiment, the measure of similarity may correspond to an edit distance between the at least one first response and the respective second responses. In an embodiment, the measure of similarity may correspond to an edit distance such as, but not limited to, a Hamming distance or a Levenshtein distance. Thereafter, in an embodiment, the one or more second responses may be ranked based at least on the measure of similarity. In an embodiment, the one or more second responses be ranked based on various other parameters such as, but not limited to, a likelihood of occurrence of a response in the one or more domain documents (determined based on the statistical model) or a performance/reputation score associated with the at least one crowdworker. In an embodiment, based on the ranking, at least one second response (from the ranked list of one or more second responses) may be selected as an acceptable response for the task. Thereafter, the at least one second response may be forwarded to the requestor of the task. A person skilled in the art would appreciate the at least one second response may be selected as the acceptable response by the requestor of the task without departing from the scope of the disclosure. In an embodiment, the requestor may be presented with the ranked list of one or more second responses from which the requestor may select the at least one second response. Alternatively, the at least one second response may be selected by the application server 106 based on one or more statistical techniques or heuristics. An embodiment of processing of the task has been further explained in conjunction with FIG. 3. Further, an embodiment of digitization of a document has been explained in conjunction with FIG. 4.

Some examples of the application server 106 may include, but are not limited to, a Java application server, a .NET framework, and a Base4 application server.

A person with ordinary skill in the art would understand that the scope of the disclosure is not limited to illustrating the application server 106 as a separate entity. In an embodiment, the functionality of the application server 106 may be implementable on/integrated with the crowdsourcing platform server 102.

The requestor-computing device 108 is a computing device used by a requestor to send the task to the application server 106. For example, the requestor may send one or more electronic documents for digitization as the at least one task to the application server 106. The application server 106 may in-turn send the at least one task to the crowdsourcing platform, for example, 104a, for crowdsourcing to the one or more crowdworkers. Further, the requestor-computing device 108 may receive the responses for the task from the one or more crowdworkers through the crowdsourcing platform (i.e., 104a), or the application server 106. Examples of the requestor-computing device 108 include, but are not limited to, a personal computer, a laptop, a personal digital assistant (PDA), a mobile device, a tablet, or any other computing device.

In an embodiment, the database server 110 is configured to store the task and the statistical model. In an embodiment, the database server 110 may receive a query from the crowdsourcing platform server 102 and/or the application server 106 to extract at least one of the task or the one or more domain documents from the database server 110. The database server 110 may be realized through various technologies such as, but not limited to, Microsoft® SQL server, Oracle, and My SQL. In an embodiment, the crowdsourcing platform server 102 and/or the application server 106 may connect to the database server 110 using one or more protocols such as, but not limited to, Open Database Connectivity (ODBC) protocol and Java Database Connectivity (JDBC) protocol.

A person with ordinary skill in the art would understand that the scope of the disclosure is not limited to the database server 110 as a separate entity. In an embodiment, the functionalities of the database server 110 can be integrated into the crowdsourcing platform server 102 and/or the application server 106.

The worker-computing device 112 is a computing device used by a crowdworker. The worker-computing device 112 is configured to present the user interface (received from the crowdsourcing platform, e.g., 104a) to the crowdworker. The crowdworker receives the one or more tasks from the crowdsourcing platform (i.e., 104a) through the user interface. Thereafter, the crowdworker submits the responses for the one or more tasks through the user interface to the crowdsourcing platform (i.e., 104a). Examples of the worker-computing device 112 include, but are not limited to, a personal computer, a laptop, a personal digital assistant (PDA), a mobile device, a tablet, or any other computing device.

The network 114 corresponds to a medium through which content and messages flow between various devices of the system environment 100 (e.g., the crowdsourcing platform server 102, the application server 106, the requestor-computing device 108, the database server 110, and the worker-computing device 112). Examples of the network 114 may include, but are not limited to, a Wireless Fidelity (Wi-Fi) network, a Wireless Area Network (WAN), a Local Area Network (LAN), or a Metropolitan Area Network (MAN). Various devices in the system environment 100 can connect to the network 114 in accordance with various wired and wireless communication protocols such as Transmission Control Protocol and Internet Protocol (TCP/IP), User Datagram Protocol (UDP), and 2G, 3G, or 4G communication protocols.

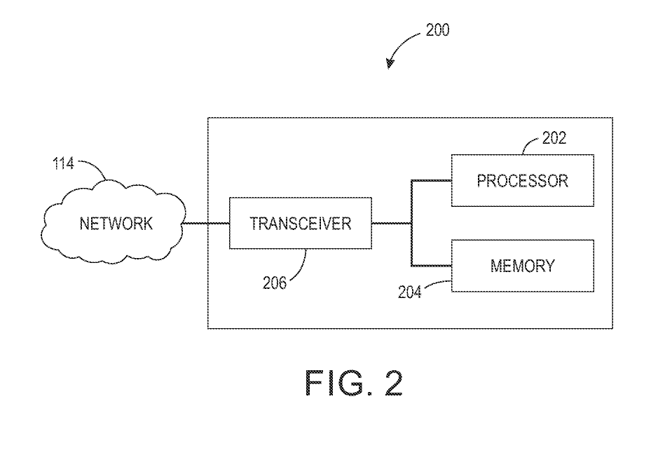

FIG. 2 is a block diagram that illustrates a system 200 for crowdsourcing a task, in accordance with at least one embodiment. In an embodiment, the system 200 may correspond to the crowdsourcing platform server 102, the application server 106, or the requestor-computing device 108. For the purpose of ongoing description, the system 200 is considered as the application server 106. However, the scope of the disclosure should not be limited to the system 200 as the application server 106. In an embodiment, the system 200 can also be realized as the crowdsourcing platform server 102 or the requestor-computing device 108 without departing from the spirit of the disclosure.

The system 200 includes a processor 202, a memory 204, and a transceiver 206. The processor 202 is coupled to the memory 204 and the transceiver 206. The transceiver 206 may connect to the network 114.

The processor 202 includes suitable logic, circuitry, and/or interfaces that are operable to execute one or more instructions stored in the memory 204 to perform predetermined operations. The processor 202 may be implemented using one or more processor technologies known in the art. Examples of the processor 202 include, but are not limited to, an x86 processor, an ARM processor, a Reduced Instruction Set Computing (RISC) processor, an Application Specific Integrated Circuit (ASIC) processor, a Complex Instruction Set Computing (CISC) processor, or any other processor.

The memory 204 stores a set of instructions and data. Some of the commonly known memory implementations include, but are not limited to, a random access memory (RAM), a read only memory (ROM), a hard disk drive (HDD), and a secure digital (SD) card. Further, the memory 204 includes the one or more instructions that are executable by the processor 202 to perform specific operations. It is apparent to a person with ordinary skills in the art that the one or more instructions stored in the memory 204 enable the hardware of the system 200 to perform the predetermined operations.

The transceiver 206 transmits and receives messages and data to/from various components of the system environment 100 (e.g., the crowdsourcing platform server 102, the requestor-computing device 108, the database server 110, and the worker-computing device 112) over the network 114. Examples of the transceiver 206 may include, but are not limited to, an antenna, an Ethernet port, a USB port, or any other port that can be configured to receive and transmit data. The transceiver 206 transmits and receives data/messages in accordance with the various communication protocols, such as, TCP/IP, UDP, and 2G, 3G, or 4G communication protocols.

The operation of the system 200 for processing the task and for digitizing a document has been described in conjunction with FIG. 3 and FIG. 4, respectively.

FIG. 3 is a flowchart 300 illustrating a method for crowdsourcing a task, in accordance with at least one embodiment. The flowchart 300 is described in conjunction with FIG. 1 and FIG. 2.

At step 302, the statistical model is created/identified from the one or more documents corresponding to a domain. In an embodiment, the processor 202 is configured to create/identify the statistical model. In an embodiment, the processor 202 may determine the domain based on a historical data associated with previous tasks sent by the requestor. In an embodiment, the historical data may include information pertaining to the domain of the previously sent tasks. Based on the determined domains (from the historical data), the processor 202 may create the statistical model for each of the determined domains. In an embodiment, the processor 202 may analyze documents related to the various domains to create the statistical models corresponding to the respective domains. In an embodiment, a domain may correspond to a field of knowledge/work/expertise, for example, a legal domain, a financial domain, a medical domain, an engineering domain, and so forth. For instance, the processor 202 may analyze one or more legal documents to create the statistical model for the legal domain. Similarly, the processor 202 may analyze one or more documents related to the financial domain, one or more documents related to the medical domain, and one or more documents related to the engineering domain to create the respective statistical models for the financial domain, the medical domain, and the engineering domain.

In an embodiment, the processor 202 may create the statistical model based on a frequency of occurrence of various words/phrases/sentences in the one or more domain documents, so analyzed. In an embodiment, the statistical model may correspond to a language model. The following table illustrates an example of a statistical model created for a legal domain:

TABLE 1
An example of a statistical model created for a legal domain

| Word/Phrase/Sentence, Wᵢ | Probability of occurrence, P(Wᵢ \| L) |
|---|---|
| Plaintiff | 0.05 |
| Defendant | 0.05 |
| Order | 0.04 |
| Testimony | 0.03 |
| Trial | 0.02 |
| Hearing | 0.02 |
| Deposition | 0.02 |
| Document | 0.02 |
| Court of Law | 0.01 |
| Civil Action | 0.01 |

As shown in Table 1 above, the words “Plaintiff” and “Defendant” occur most frequently in the legal domain with an occurrence probability of 0.05 each (or 5%), followed by the word “Order” with an occurrence probability of 0.04 (i.e., 4%), and so on. A person skilled in the art would appreciate that the statistical model illustrated above is for the purpose of example and should not be construed to limit the scope of the disclosure.

In an embodiment, the processor 202 may store the statistical model within a data structure such as, but not limited to, a Bloom filter, a Tries, or a BK tree. In an embodiment, the processor 202 may determine the type of data structure to be utilized for storing the statistical model based on one or more query performance requirements such as, but not limited to, a minimum searching time, a minimum storage space, a minimum temporary/buffer storage space, a minimum query complexity, and so forth.

### Bloom Filters

A Bloom filter is a probabilistic data structure which may accept new elements, but from which elements may not be removed. Hence, Bloom filters may generate false positives but may not generate false negatives. Further, Bloom filters may be space efficient as compared to the other data structures.

When a Bloom Filter is used to store the statistical model, for searching a given word, a set of all words within a pre-determined Levenshtein distance from the word are determined. Thereafter, a check is performed to determine which of the words in this set existed in a previously created statistical model. Further, another data structure storing the entire list of words may be scanned to verify whether or not the existence of the word within the list is a false positive. Further, the probability of occurrence of the word within the one or more domain documents may also be determined from the other data structure.

### Tries

A Tries is an ordered tree data structure with an empty string as the root of the tree. In case of Tries, no node of the tree stores the key associated with that node, instead, position of the node within the tree is deterministic of the key associated with the node. Further, descendants of each node have a common prefix of a string associated with that node. A Tries data structure may be utilized to store a dynamic or associative dataset with strings as keys. An advantage of Tries data structure may be that it may be time efficient and may require only O(m) traversal time to search for a string of length ‘m’.

When a Tries is used to store the statistical model, for searching against a target word, a set of all words within a pre-determined Levenshtein distance from the target word is determined. Thereafter, each word is in the set of words in checked in the Tries. If the word exists, the probability of occurrence of the word within the one or more domain documents may be determined from the Tries.

### BK Tree

A BK tree is a data structure which is utilizable for spell checking based on Levenshtein distance between two words. A BK tree may store a word as a root and one or more words at a pre-determined Levenshtein distance from the word as the various nodes of the tree. Hence, a BK tree may be time efficient to query and may require only O(log m) traversal time to search for a word. However, a BK tree may be space inefficient.

When used for storing the statistical model, multiple BK tree data structure may be used, one for each word. Each BK tree data structure may store a word and various words at pre-determined Levenshtein distance from the word. During querying of the statistical model, the BK tree corresponding to the target word may be queried for the nearest words to the target word and their probability of occurrences within the one or more domain documents.

A person skilled in the art would appreciate that the processor 202 may utilize any or a combination of the above enumerated data structures for storing the statistical model. Further, various other types of data structures may be utilized to store the statistical model without departing from the scope of the disclosure.

In an embodiment, the processor 202 may store the data structure containing the statistical model in the database server 108. In an embodiment, the data structure may be queried to determine a probability of occurrence of a word/phrase/sentence within the one or more domain documents, which may be determined based on the statistical model.

In an embodiment, the processor 202 may receive the task from the requestor. Thereafter, the processor 202 may determine the domain associated with the task. For example, if the task corresponds to a form digitization task, the processor 202 may apply one or more machine learning or one or more image processing techniques to identify at least a portion of the content of the form. For instance, the processor 202 may employ an Optical Character Recognition (OCR) or an Intelligent Character Recognition (ICR) technique to identify one or more fields in the form. Based on such identification, the processor 202 may determine the domain of the form and in-turn that of the task. Further, the requestor may provide an input corresponding to the domain of the task, which may be utilized to identify the domain of the task.

Based on the domain of the task, in an embodiment, the processor 202 may identify the statistical model that is related to the domain from the database server 108. For example, if the task is related to a legal domain, the processor 202 may select the statistical model related to the legal domain. However, if no statistical model corresponding to the domain of the task exists, in an embodiment, the processor 202 may collate one or more documents associated with such domain from various sources such as, but not limited to, one or more internet repositories, one or more search engines, one or more indexed databases, and so forth. Further, as explained above, the processor 202 may analyze the one or more collated documents to create a fresh statistical model for the domain of the task. Further, any subsequent task having the same domain may utilize the newly created statistical model.

A person skilled in the art would appreciate that the information pertaining to tasks submitted (including domain of the tasks) on the crowdsourcing platform, for example, 104a, may be utilized to create the statistical models based on the respective domains of the tasks. In an embodiment, such information may be maintained by the crowdsourcing platform, for example, 104a. In an embodiment, the processor 202 may periodically request for such information create new statistical models or update older statistical models.

Thereafter, in an embodiment, the task may be crowdsourced to one or more crowdworkers. In an embodiment, the processor 202 may upload the task on the crowdsourcing platform, for example, 104a. The crowdsourcing platform, that is, 104a, may in-turn crowdsource the task to one or more crowdworkers.

At step 304, the at least one first response is received for the task from at least one crowdworker. In an embodiment, the processor 202 is configured to receive the at least one first response. As discussed earlier, the task is crowdsourced to one or more crowdworkers through the crowdsourcing platform, for example, 104a. In response to the crowdsourcing of task, in an embodiment, the at least one first response may be received from at least one of the one or more crowdworkers, via the crowdsourcing platform, that is, 104a.

At step 306, the one or more second responses, corresponding to intended responses to the task, are determined based on the at least one first response and the statistical model. In an embodiment, the processor 202 is configured to determine the one or more second responses, which correspond to intended responses for the task. In an embodiment, the processor 202 may query the data structure storing the statistical model based on the at least one first response to determine the one or more second responses. To that end, in an embodiment, the processor 202 may send (through the transceiver 206) a query to the database server 108 for determining the one or more second responses. In an embodiment, the query may include the at least one first response. For example, if the at least one first response includes the word “consigns”, the one or more second responses may include the words “consigns,” “consign,” “consigned,” “consignable,” “consignation,” “consignor,” “consigner,” “consignment,” “consignee,” and “consigning.”

In an embodiment, each of the one or more second responses may be within a pre-determined edit distance from the at least one first response. In an embodiment, the pre-determined edit distance may be specified by the requestor. In addition, the pre-determined edit distance may be changed, that is, increased or decreased, by the requestor based on the one or more second responses obtained from the initial value of the pre-determined edit distance. For instance, in the above example, the pre-determined edit distance may be 5 as the word “consignation” is the farthest from the word “consigns” at that edit distance, that is, at an edit distance of 5.

At step 308, the one or more second responses are ranked. In an embodiment, the processor 202 is configured to rank the one or more second responses based on a measure of similarity of each of the one or more second responses with the at least one first response. Further, in an embodiment, the one or more second responses may also be ranked based on other criteria such as, but not limited to, the likelihood of occurrence of the responses in the one or more domain documents associated with the statistical model and the performance/reputation score of the at least one crowdworker.

Measure of Similarity of Second Responses from at Least One First Response

In an embodiment, the measure of similarity may correspond to a minimum edit distance between the one or more second responses and the at least one first response. In an embodiment, the processor 202 may determine the minimum edit distance by utilizing one or more techniques such as, but not limited to, a Hamming distance or a Levenshtein distance. In the above example, if the at least one first response is the misspelt word “consigne”, the ranking of the one or more second responses based on the Levenshtein distance between the responses is illustrated in the table below:

TABLE 2
Example ranking of the responses based on Levenshtein distance

| Ranked list of one or more | Levenshtein distance from at least one |
|---|---|
| second responses | first response “consigne” |
| consigne | 0 |
| consign | 1 |
| consigns | 1 |
| consigned | 1 |
| consigner | 1 |
| consignee | 1 |
| consignor | 2 |
| consigning | 3 |
| consignable | 4 |
| consignment | 4 |
| consignation | 5 |

As shown in the above table, the words “consign,” “consigned,” “consignor,” “consigner,” and “consignee” are at a minimum edit distance of 1 from the word “consigne” (the at least one first response), and are thus may be assigned a higher rank than the rest of the second responses. Further, the word “consignation” may be assigned a lower rank among the second responses, as it is at an edit distance of 5 from the word “consigne” (the at least one first response).

### Likelihood of Occurrence of Second Responses in the One or More Domain Documents

In an embodiment, the likelihood of occurrence of the second responses in the one or more domain documents may be determined from the statistical model based on the at least one first response. For example, the words “consignee”, “consignor”, and “consigner”, may have a likelihood of occurrence of 0.05 each in the domain documents, while the words “consign”, “consigns”, and “consigned” may have a likelihood of occurrence of 0.04 each in the domain documents. In such a scenario, the words “consignee”, “consignor”, and “consigner” may be ranked higher than the words “consign”, “consigns”, and “consigned”.

Performance/Reputation Score Associated with Crowdworkers

In an embodiment, the performance/reputation score of the one or more crowdworkers may be obtained from the crowdsourcing platform, e.g., 104a, and thereafter normalized to lie within a range of 0 to 1. In an embodiment, the normalized performance/reputation score of the crowdworkers may be determined using the following equation:

$${n}_{i} = \frac{{r}_{i}}{{\sum }_{j = 1}^{j = N} {r}_{j}} \qquad ( 1 )$$

where,

nᵢ: normalized performance/reputation score of i^{th} crowdworker,

rᵢ: performance/reputation score associated with the i^{th} crowdworker, and

N: a number of crowdworkers, who perform a particular task.

In an embodiment, a weighted score may be assigned to each of the one or more second responses based on the measure of similarity of second responses from at least one first response, the likelihood of occurrence of second responses in the one or more domain documents, and the performance/reputation score associated with the crowdworkers. Thereafter, the one or more second responses are ranked based on the weighted score by utilizing the following equation:

$$Score ( {SR}_{i} ) = ( \frac{1}{ \begin{matrix}measure of similarity of \\ SRi with at least one first response\end{matrix}} ) * w 1 + ( probability of occurrence of SRi within domain documents ) * w 2 + ( normalized reputation or performance score of crowdworkers providing response SRi ) * w 3 \qquad ( 2 )$$

where,

SRᵢ: second response

Score(SRᵢ): weighted score for the i^{th} second response, SRᵢ,

w1, w2, and w3: weights used to determine the weighted score (which may be pre-determined or provided by the requestor).

A person skilled in the art would appreciate that any statistical technique known in the art may be used to rank the one or more second responses based on the multiple criteria, as specified above, without departing from the scope of the disclosure. Further, any other criteria, than that specified above, may also be used to perform the ranking of the one or more second responses.

At step 310, at least one second response is selected from the one or more second responses as an acceptable response for the task. In an embodiment, the processor 202 is configured to select at least one second response from the one or more second responses as the acceptable response for the task. In an embodiment, the requestor may be presented with the ranked list of one or more second responses. The requestor may select a response from this ranked list of one or more second responses as the acceptable response for the task. Alternatively, without the requestor's input, the processor 202 may automatically select the at least one second response as the acceptable response for the task.

Post determining the acceptable response for the task, the processor 202 may forward the acceptable response to the requestor.

FIG. 4 is a flowchart 400 that illustrates a method for digitizing a document, in accordance with at least one embodiment. The flowchart 400 is described in conjunction with FIG. 1, FIG. 2, and FIG. 3.

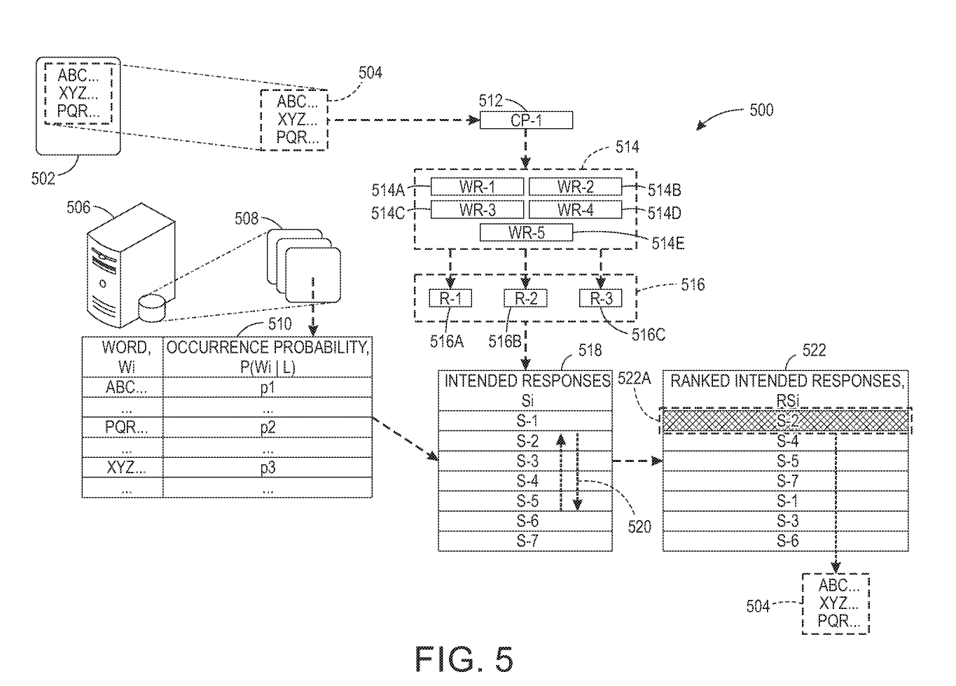

At step 402, a document is received. In an embodiment, the processor 202 is configured to receive the document. In an embodiment, a requestor may scan the document through a scanner or a Multi-Function Device (MFD), or an image capture device. In an embodiment, the functionality of scanning the document may be embedded within the requestor-computing device 110. In an embodiment, the document may include a handwritten portion or an image portion that may require to be transcribed manually. In an embodiment, the requestor may select a portion of the document (e.g., the handwritten portion or the image portion), through the user-interface of the requestor-computing device 110, as at least one portion to be digitized through crowdsourcing. Post scanning the document and selecting the at least one portion, the scanned electronic document and information associated with the at least one portion is received at the application server 106 for crowdsourcing through the crowdsourcing platform, for example, 104a. An example of the at least one portion of the document is illustrated in FIG. 5.

At step 404, a language model is created based on a domain of document. In an embodiment, the processor 202 is configured to create the language model. To that end, in an embodiment, the processor 202 may first determine the domain of the document. In an embodiment, the domain of the document may be determined based on information provided by the requestor. In another embodiment, the processor 202 may utilize one or more image analysis algorithms such as, but not limited to, Optical Character Recognition (OCR) or Intelligent Character Recognition (ICR) to determine the domain associated with the document. A person skilled in the art would appreciate that any other technique may be utilized to determine the domain of the document without departing from the scope of the disclosure.

Post determining the domain of the document, in an embodiment, the processor 202 may analyze one or more documents related to the domain, so determined. Based on such analysis, the processor 202 may create the language model. The creation of the language model is similar to the creation of the statistical model, as described above in step 302. Further, in an embodiment, as discussed above, the processor 202 may store the language model within a data structure such as, but not limited to, a Bloom filter, a Tries, or a BK tree. In an embodiment, the processor 202 may store the data structure containing the language model on the database server 108.

A person skilled in the art would appreciate that the language model may not be created for the document if a language model associated with the domain of the document already exists, in a manner similar to that described in step 302. Hence, the processor 202 may first check the existing language models and the domains associated with each of the existing language models. If a language model corresponding to the domain of the document exists, the processor may use such language model for the document instead of creating the language model afresh.

Further, the at least one portion of the document is submitted on the crowdsourcing platform, for example, 104a. The crowdsourcing platform, that is, 104a may offer the at least one portion as a task to one or more crowdworkers. In response to crowdsourcing the task to the one or more crowdworkers, one or more responses may be received from the one or more crowdworkers. In an embodiment, the one or more responses may include a transcription of content within the at least one portion of the document.

At step 406, at least one first transcription of content of the at least one portion is received from at least one crowdworker. In an embodiment, the processor 202 is configured to receive the at least first transcription of content of the at least one portion from the at least one crowdworker, through the crowdsourcing platform, for example, 104a.

At step 408, one or more second transcriptions, corresponding to intended transcriptions for the at least one portion, are determined. In an embodiment, the processor 202 is configured to determine the one or more second transcriptions based on the language model. In an embodiment, the one or more second transcriptions may correspond to intended transcriptions for the at least one portion of the document. In an embodiment, the processor 202 may determine the one or more second transcriptions in a manner similar to that described in step 306.

At step 410, the one or more second transcriptions are ranked. In an embodiment, the processor 202 is configured to rank the one or more second transcriptions based at least one of a measure of similarity of the second transcriptions with the at least one first transcription, a likelihood of occurrence of the transcriptions in the one or more domain documents associated (determined based on the language model), and a performance/reputation score associated with the at least one crowdworker. In an embodiment, the processor 202 may rank the one or more second transcriptions in a manner similar to that described in step 308, based on a weighted score assigned to each second transcription using equation 2.

At step 412, at least one second transcription is selected from the one or more second transcriptions as an acceptable transcription for the at least one portion. In an embodiment, the processor 202 may select the one second transcription from the one or more second transcriptions as the acceptable transcription for the at least one portion of the document. In an embodiment, the processor 202 may present the ranked list of one or more second transcriptions to the requestor. The requestor may select a best transcription as the acceptable transcription for the at least one portion. Alternatively, without the requestor's input, the processor 202 may automatically select the at least one second transcription as the acceptable transcription for the at least one portion.

Post determining the acceptable transcription for the portion, the processor 202 may forward the acceptable transcription to the requestor.

FIG. 5 is a flow diagram 500 illustrating an example of digitization of a document 502, in accordance with at least one embodiment. FIG. 5 has been explained in conjunction with FIG. 1, FIG. 2, FIG. 3, and FIG. 4.

As shown in FIG. 5, the document 502 includes at least one portion (depicted by 504) that is to be digitized through crowdsourcing. As discussed (refer step 402), in an embodiment, the document may be received from the requestor-computing device 110. Further, the at least one portion (depicted by 504) of document (depicted by 502) may be selected by the requestor through a user-interface of the requestor-computing device 110. Alternatively, the at least one portion (depicted by 504) may be determined based on one or more image processing and/or machine learning techniques.

Thereafter, one or more documents (depicted by 508) related to the domain of the document 502 may be analyzed to create a language model (depicted by 510). In an embodiment, the domain related to the document 502 may be provided by the requestor. Alternatively, the domain may be determined based on an analysis of one or more portions of the document 502 by utilizing one or more image processing and/or machine learning techniques. In an embodiment, the language model may be stored in a database (depicted by 506) within a data structure such as, but not limited to, a Bloom filter, a Tries, or a BK tree. As discussed above, the language model (depicted by 510) is a mapping table containing words/sentences/phrases (denoted by Wᵢ) occurring within the one or more domain documents (depicted by 508) with corresponding occurrence probabilities (denoted by P (Wᵢ|L)).

Prior to creating the language model (depicted by 510), the database 506 may first be queried to determine whether a language models corresponding to the domain of the document 502 is already stored in the database 506. If yes, the pre-existing language model may be used. A fresh language model may only be created of a pre-existing language model associated with the domain of the document 502 is not found in the database 506. The creation of the language model has been explained further in step 404.

Further, the at least one portion (depicted by 504) of the document (depicted by 502) is crowdsourced as a task on a crowdsourcing platform, say CP-1 (denoted by 512), for digitization of the content within the at least one portion (depicted by 504). Thereafter, the task may be pushed to/pulled by one or more crowdworkers (collectively depicted by 514), such as the five crowdworkers, WR-1 (depicted by 514a), WR-2 (depicted by 514b), WR-3 (depicted by 514c), WR-4 (depicted by 514d), and WR-5 (depicted by 514e), as shown in FIG. 5. In response to crowdsourcing the task to the one or more crowdworkers (depicted by 514), one or more responses (collectively depicted by 516) may be received. For instance, as shown in FIG. 5, responses R-1 (depicted by 516a), R-2 (depicted by 516b), and R-3 (depicted by 516c) are received. In an embodiment, the one or more received responses (depicted by 516) may include at least one first transcription for the content within the at least one portion (depicted by 504) of the document 502 (refer step 406).

Thereafter, one or more second transcriptions corresponding to intended transcriptions/responses, Sᵢ (depicted by 518) are determined based on the at least one first transcription (within the one or more received responses 516) and the language model (depicted by 510). For instance, as shown in FIG. 5, the list of intended transcriptions/responses (depicted by 518) include S-1, S-2, S-3, S-4, S-5, S-6, and S-7. The determination of the one or more second transcriptions (i.e., intended transcriptions/responses) is explained further in step 408.

Further, the list of intended transcriptions/responses (depicted by 518) is ranked (denoted by 520) based on at least one of a measure of similarity of the intended transcriptions/responses (depicted by 518) with the at least one first transcription (within the one or more received responses 516), a likelihood of occurrence of the transcriptions (depicted by 518) in the language model (depicted by 510), and a performance/reputation score associated with the crowdworkers 514. In an embodiment, the ranking of the intended transcriptions/responses may be based on a weighted score assigned to each of the intended transcriptions by utilizing equation 2. The ranking of the intended transcriptions/responses has been further explained in step 410.

The ranked list of intended transcriptions/responses has been depicted by the table 522 in FIG. 5. As shown in the table, the intended transcription S-2 (depicted by 522a) has been assigned the highest rank, and thus, is selected as an acceptable transcription for the at least one portion 504 (refer step 412).

A person skilled in the art would understand that the scope of the disclosure should not be limited to digitization of a document through crowdsourcing, as described above. The disclosure may be implemented for crowdsourcing of any type of task such as, but not limited to, image/video/text labelling/tagging/categorisation, language translation, data entry, handwriting recognition, product description writing, product review writing, essay writing, address look-up, website look-up, hyperlink testing, survey completion, consumer feedback, identifying/removing vulgar/illegal content, duplicate checking, problem solving, user testing, video/audio transcription, targeted photography (e.g. of product placement), text/image analysis, directory compilation, or information search/retrieval. Further, the examples used in the disclosure are for illustrative purposes only, and should not be construed to limit the scope of the disclosure.

The disclosed embodiments encompass numerous advantages. Various embodiments of the disclosure lead to a minimization of manual errors that may creep in while a task is performed by one or more crowdworkers. The analysis of the one or more domain documents related to a field of the task leads to a creation/identification of a relevant statistical/language model. The responses received on crowdsourcing of the task to the one or more crowdworkers are used to query the statistical/language model to retrieve a list of close matches, referred as one or more second responses or intended responses. Thereafter, as discussed above, the intended responses are ranked based on various criteria. Further, the ranked list of intended responses may be presented to the requestor of the task. Alternatively, one or more machine learning techniques may be used to analyze the list of intended responses. Finally, one of the top ranking intended responses may be selected as an acceptable response for the task. Thus, the disclosure provides for removal of errors of omission/commission in performance of the task, or in the task itself.

The disclosed methods and systems, as illustrated in the ongoing description or any of its components, may be embodied in the form of a computer system. Typical examples of a computer system include a general purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or similar devices that enable the computer system to connect to databases and networks such as LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks such as steps that constitute the method of the disclosure. The systems and methods described can also be implemented using only software programming, only hardware, or a varying combination of the two techniques. The disclosure is independent of the programming language and the operating system used in the computers. The instructions for the disclosure can be written in all programming languages including, but not limited to, “C,” “C++,” “Visual C++,” and “Visual Basic”. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, “Unix,” “DOS,” “Android,” “Symbian,” and “Linux.”

The programmable instructions can be stored and transmitted on a computer-readable medium. The disclosure can also be embodied in a computer program product comprising a computer-readable medium, with any product capable of implementing the above methods and systems, or the numerous possible variations thereof.

Various embodiments of the methods and systems for digitizing a document have been disclosed. However, it should be apparent to those skilled in the art that modifications, in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art that are also intended to be encompassed by the following claims.

What is claimed is:

1. A method for digitizing a document, the method comprising:
receiving, by one or more processors, at least one first transcription of content of at least one portion of the document from at least one crowdworker, wherein the first transcription is received in response to the at least one portion being crowdsourced as a digitization task to the at least one crowdworker;
determining, by the one or more processors, one or more second transcriptions based on the at least one first transcription, wherein the one or more second transcriptions correspond to intended transcriptions for the at least one portion; and
ranking, by the one or more processors, the one or more second transcriptions based at least on a measure of similarity between the at least one first transcription and each of the one or more second transcriptions, wherein at least one second transcription is selected from the one or more second transcriptions as an acceptable transcription for the at least one portion, based on the ranking.

2. The method of claim 1, wherein the one or more second transcriptions are determined using a data structure, wherein the data structure is created based on one or more second documents associated with a domain of the document.

3. The method of claim 2, wherein the data structure comprises a language model, wherein the language model is utilizable to determine a likelihood of occurrence of the one or more second transcriptions within the one or more second documents.

4. The method of claim 3, wherein the ranking is based on the likelihood of occurrence of the one or more second transcriptions within the one or more second documents.

5. The method of claim 2, wherein the data structure corresponds to at least one of a Bloom filter, a Tries, or a BK tree.

6. The method of claim 1, wherein the ranking is based on a performance/reputation score associated with the at least one crowdworker.

7. The method of claim 1, wherein the measure of similarity corresponds to a Levenshtein distance.

8. A system for digitizing a document, the system comprising:
one or more processors configured to:
receive at least one first transcription of content of at least one portion of the document from at least one crowdworker, wherein the first transcription is received in response to the at least one portion being crowdsourced as a digitization task to the at least one crowdworker;
determine one or more second transcriptions based on the at least one first transcription, wherein the one or more second transcriptions correspond to intended transcriptions for the at least one portion; and
rank the one or more second transcriptions based at least on a measure of similarity between the at least one first transcription and each of the one or more second transcriptions, wherein at least one second transcription is selected from the one or more second transcriptions as an acceptable transcription for the at least one portion, based on the ranking.

9. The system of claim 8, wherein the one or more second transcriptions are determined using a data structure, wherein the data structure is created based on one or more second documents associated with a domain of the document.

10. The system of claim 9, wherein the data structure comprises a language model, wherein the language model is utilizable to determine a likelihood of occurrence of the one or more second transcriptions within the one or more second documents.

11. The system of claim 10, wherein the ranking is based on the likelihood of occurrence of the one or more second transcriptions within the one or more second documents.

12. The system of claim 8, wherein the ranking is based on a performance/reputation score associated with the at least one crowdworker.

13. A computer program product for use with a computer, the computer program product comprising a non-transitory computer readable medium, wherein the non-transitory computer readable medium stores a computer program code for digitizing a document, wherein the computer program code is executable by one or more processors to:
receive at least one first transcription of content of at least one portion of the document from at least one crowdworker, wherein the first transcription is received in response to the at least one portion being crowdsourced as a digitization task to the at least one crowdworker;
determine one or more second transcriptions based on the at least one first transcription, wherein the one or more second transcriptions correspond to intended transcriptions for the at least one portion; and
rank the one or more second transcriptions based at least on a measure of similarity between the at least one first transcription and each of the one or more second transcriptions, wherein at least one second transcription is selected from the one or more second transcriptions as an acceptable transcription for the at least one portion, based on the ranking.

14. The computer program product of claim 13, wherein the one or more second transcriptions are determined using a data structure, wherein the data structure is created based on one or more second documents associated with a domain of the document.

15. The computer program product of claim 14, wherein the data structure comprises a language model, wherein the language model is utilizable to determine a likelihood of occurrence of the one or more second transcriptions within the one or more second documents.

16. The computer program product of claim 15, wherein the ranking is based on the likelihood of occurrence of the one or more second transcriptions within the one or more second documents.

17. The computer program product of claim 13, wherein the ranking is based on a performance/reputation score associated with the at least one crowdworker.

18. A method for processing a task, the method comprising:
receiving, by one or more processors, at least one first response for the task from at least one crowdworker, wherein the at least one first response is received in response to the task being crowdsourced to one or more crowdworkers;
determining, by the one or more processors, one or more second responses based on the at least one first response, wherein the one or more second responses correspond to intended responses for the task; and
ranking, by the one or more processors, the one or more second responses based at least on a measure of similarity between the at least one first response and each of the one or more second responses, wherein at least one second response is selected from the one or more second responses as an acceptable response for the task, based on the ranking.
